(19) United States
(12) Patent Application Publication
(10) Pub. No.: US 2005/0268467 A1
(43) Pub. Date: Dec. 8, 2005

(54) Plant deleafing tool

(76) Inventor: Jackie Woods-Hunter, Decatur, GA (US)

Correspondence Address: MICHAEL A. SHIPPEY, PH. D., 4848 LAKEVIEW AVENUE, SUITE B, YORBA LINDA, CA, 92886, US

(21) Appl. No.: 10/862,290

(22) Filed: Jun. 5, 2004

(51) Int. Cl. A01C 1/00

(52) U.S. Cl. 30/90.4

(57) ABSTRACT

The present invention is a multi-purpose hand tool that can remove foliage from vegetables and other plants, including flowers. It can also be used for various other jobs, including the removal of plastic coating on electrical wiring, thorns on roses, and to snip stems. The dual retractable blades eliminate the need to pull foliage from the stem by hand, making it possible to stem both sides at once with one swift upward motion of the instrument. The dual handles increase the ease-of-use for people who have difficulty gripping small objects. This enables quicker preparation and clean-up because you can stem and snip with one pull and the greens need not be cut apart first.

### FIELD OF THE INVENTION

The present invention relates to the field of hand tools, and more particularly to gardening and culinary hand tools.

### DESCRIPTION OF PRIOR ART

The present invention relates to the field of agricultural and home & garden tools, and more particularly to tools that will specifically remove the leaves of plants, whether for culinary or decorative purposes. Prior art has developed peelers that are widely used in the preparation of fruits and vegetables. They are usually comprised of specially affixed or rotating cutting blades that are often mounted upon handles. Battery operated or electrically motorized versions have not proven completely satisfactory due to mechanical complications, bulkiness, and lack of versatility, which has increased the difficulty of their use.

The bulk of the prior art effort in developing deleafing tools has been directed at large scale machinery for farm and factory use. Developments of satisfactory hand deleafing tools have lagged behind the art.

### SUMMARY OF THE INVENTION

The present invention relates to the field of kitchen and garden trimming tools, and more particularly to the field of vegetable and flower trimming tools. It is a manual handheld device used to strip thorns from the stems of flowers quickly and safely, as well as peeling certain types of vegetables and fruits. By placing the mouth of the instrument around the base of the flowers'stem and pulling upward in one swift motion the foliage is stripped away from both sides of the stem simultaneously. It is also used for removing foliage from the large stems of collards and other leafy green vegetables. It has the size and approximate shape of standard household pliers, but with a horizontal pair of cutting blades along the inside of the jaws for snipping leaves off of stems, and other cutting actions. The handles are made of steel with a plastic/rubberized coating covering the midsection for easier gripping. The two arms are connected by screw and bolt. A retractable steel blade operated by a pushbutton mechanism is an optional additional feature.

### BRIEF DESCRIPTION OF DRAWINGS

FIG. 1 is an overview of a preferred embodiment of the present invention showing the tool in the closed position, from a full plan view. All pertinent elements of the present invention are called out, including jaws 14, 16, with the cutting blades 10, 12; handles 2,4; compression spring 6; and pivot point 8.

In FIG. 2, the preferred embodiment is shown in the open (ready) position with handles 2,4 and jaws of tool 14, 16 in the open position. The dotted line arrows call out the expansion view in FIG. 3.

FIG. 3 shows a cutaway view of the jaws, exposing the cutting blades 10, 12.

FIG. 4 shows a side profile view of the preferred embodiment of the present invention.

FIG. 5 shows an expanded side view of the head of the present invention, in use, removing the leaves from the stem of a plant. The jaws of the tool 14, 16 are seen closed around the stem 50, with the cutting blades 10, 12 in direct contact with the stem.

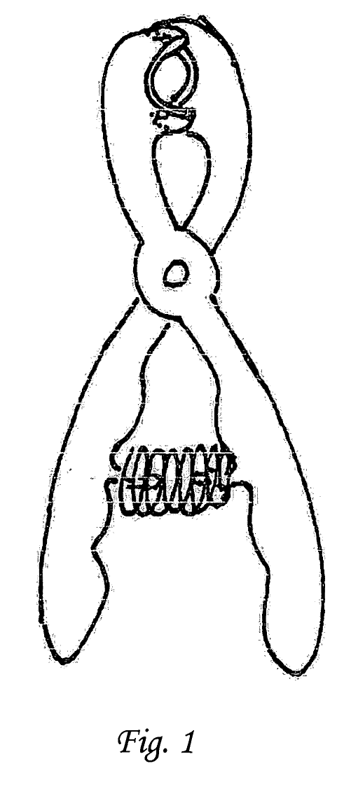

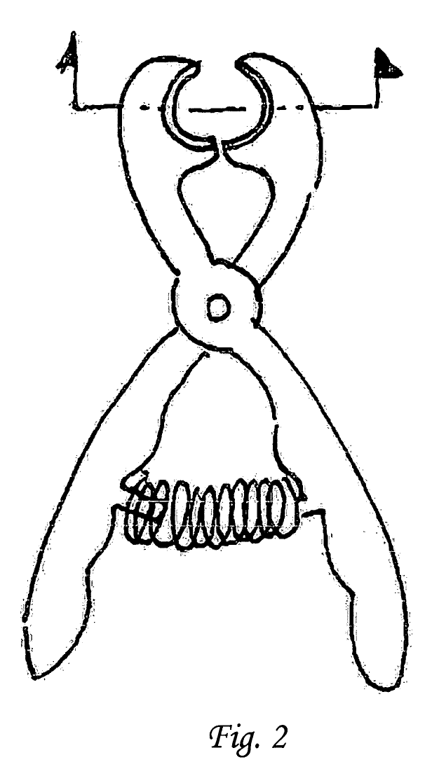

### OBJECTS OF THE INVENTION

It is an object of the present invention to provide a hand tool for the easy and quick removal of leaves from a plant or plant cutting.

It is another object of the present invention to provide a hand tool that is durable, uncomplicated, safe, and easy to use.

It is a further object of the present invention to provide a hand tool that can be used in and around the home to provide decorative cuttings of flowers and other plants.

It is yet another object of the present invention to provide a hand tool that can be used in the kitchen for the preparation of foods.

It is still another object of the present invention to provide a hand tool that can be used in the removal of surface material from virtually any small diameter cylindrical stem

Further objects of the present invention will become apparent upon review of the full disclosure, including drawings, contained herein.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

This invention is for the purpose of removing foliage from vegetable, flowers, and other plants. This new invention could serve various other purposes as well.

FIG. l displays a preferred embodiment of the present invention. The invention in this view resembles a pair of pliers with two steel blades 10,12 (optionally retractable) pointing inward from the arcuate jaws 14,16. As in most pliers, the jaws are operated by means of squeezing handles, which are connected to the jaws through a pivot point. In the present invention, arcuate handles 2,4 pivot around pivot screw 8, thereby moving jaws 14,16 and thereby squeezing blades 10, 12 together.

The two steel blades 10, 12 inside the mouth are used for snipping stems or other things. The retractable blade feature is for the purpose of removing foliage from large stems of collards and other vegetables easily and quickly. Once done with that task, there remains the option to snip the stem if one chooses with the snipper feature of the tool residing within the jaws. Theses same blades 10, 12 serve the purpose of snipping thicker and larger stems if needed.

To operate this new invention, place the stem between the cutting blades 10, 12 and slide the instrument along the stem, therefore cutting off any protrusions in its path. This new invention can eradicate foliage on both sides of the stem with one quick motion as well as snip, eliminating the need for an additional tool or the use of hands.

This tool works especially well for people with difficulty handling small objects. Preparation and cleanup time is minimized. This new tool can also be used by electricians, plumbers, mechanics, or any other profession where any cutting or stripping of material is needed.

FIG. 2 shows the preferred embodiment in an open position. It will be noted that compression spring 6 is capable of being detached at one end from its receiving port 20.

This position may be used for stripping larger diameter stems, or for cleaning the invention, etc.

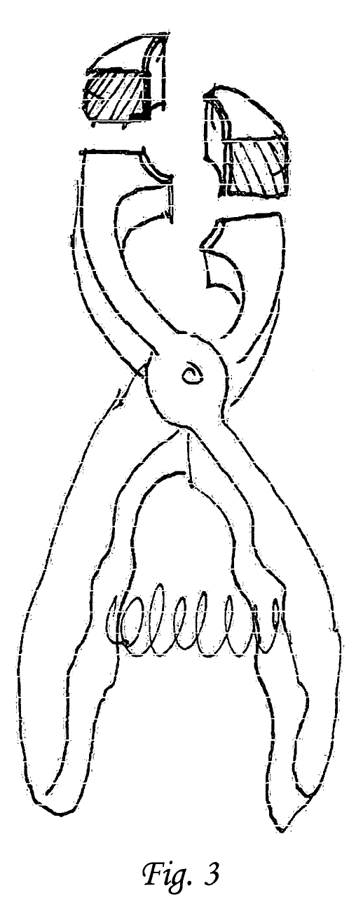

FIG. 3 displays the preferred embodiment with a cross-sectional view through the jaws. The steel blades 10, 12 are clearly displayed along the inside of the jaw arms.

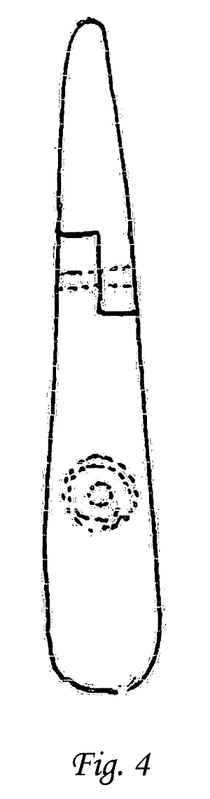

FIG. 4 displays a side view of the preferred embodiment of the present invention. The device is very slim from this angle. It is easily handled and stored.

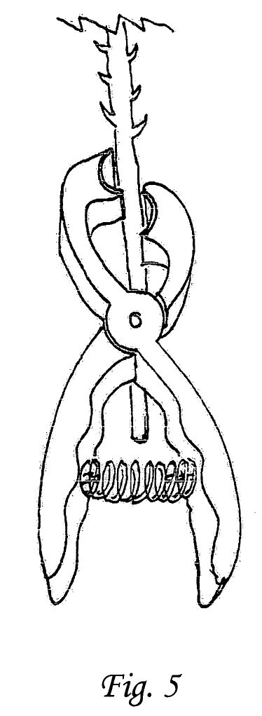

FIG. 5 shows the preferred embodiment in closed position around a stem, from an end-on position. Jaws 14, 16 are clearly seen, but cutting blades 10, 12 are just barely visible next to the stem. This illustrates the preferred mode of operation of the device to remove leaves from a stem. The device is pulled along the length of a stem, and the steel blades surround the stem and remove the leaves via a stripping action.

In the optional retractable blade embodiment, the device can be used with blades retracted as normal pliers, for grasping objects. Alternatively, they can be used for blunt-edge stripping, where sharp cutting edges are not desired.

The retractable feature of the cutting edge blades can be incorporated into the present invention by a number of different routes. One simple method is to have a slide button on the inside of a handle (2 or 4), perhaps located just above or below compression spring 6. The button will be connected to a cable that runs inside the handle, up to the jaws, perhaps bifurcating to reach both jaws 14 and 16. The cable is just long enough to connect fixedly to cutting edges 10, 12 when the slide is in the up position and the cutting edges are extended. Then, when the slide is moved to the down position, the cutting edges are retracted into the jaws, which will have openings suitable for concealing the cutting edges while in retracted position.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

1. A cutting tool, comprising:
Two opposing arcuate handles, connected at a pivot point,
each said handle extending past said pivot point to form one member of a pair of opposable jaws;
said jaws being curved at each open end, and,
each said jaw member having a blade attached at said open end:

2. The cutting tool of claim 1, wherein said blades are retractable into said jaws.

3. The cutting tool of claim 1, wherein said pivot point comprises a fulcrum shaft.

4. The cutting tool of claim 1, wherein said jaws are capable of encircling a stem of diameter 3 centimeters or smaller.

5. The cutting tool of claim 1, wherein said handles are joined at a point intermediate between said pivot point and the open end of said handles by a tensioning means.

6. The cutting tool of claim 5, wherein said tensioning means comprise a compression spring.

7. The cutting tool of claim 5, wherein said compression spring is fixedly attached at one end to a handle, and removably attached at the other end to the opposite handle.

8. The use of cutting tool of claim 1 to strip leaves and other surface material from a substantially cylindrical stem.
